(19) United States
(12) Patent Application Publication
(10) Pub. No.: US 2025/0234446 A1
(43) Pub. Date: Jul. 17, 2025

(54) ROTATIONAL DISK STRUCTURE FOR EUV LIGHT SOURCE DEVICE

(71) Applicant: ESOL, Inc., Hwaseong-si (KR)

(72) Inventor: Dong Gun LEE, Hwaseong-si (KR)

(73) Assignee: ESOL, Inc., Hwaseong-si (KR)

(21) Appl. No.: 18/954,348

(22) Filed: Nov. 20, 2024

(30) Foreign Application Priority Data
Jan. 11, 2024 (KR) 10-2024-0004849
Aug. 5, 2024 (KR) 10-2024-0104041

(51) Int. Cl. H05G 2/00

(52) U.S. Cl. CPC H05G 2/0082; H05G 2/0023

(57) ABSTRACT

The present invention relates to a rotational disk structure for an EUV light source device, including: a rotational disk confining a target material by centrifugal force while rotating to generate EUV light through plasma reactions with the target material in the EUV light source device, wherein the rotational disk includes a plurality of rotational disk ribs supporting a rotational disk rim to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

### CROSS REFERENCE TO RELATED APPLICATION OF THE DISCLOSURE

The present application claims the benefit of Korean Patent Application Nos. 10-2024-0004849 filed on Jan. 11, 2024, and 10-2024-0104041 filed on Aug. 5, 2024, the entire contents of which are incorporated herein by reference.

### BACKGROUND OF THE INVENTION

### Field of the Invention

The present invention relates to a rotational disk structure for an EUV light source device, and more specifically, to a rotational disk structure for an EUV light source device, which can significantly enhance light collection efficiency.

### Background Art

Methods for producing EUV light include a process of converting a material into a plasma state which has at least one element, such as xenon, lithium or tin, with at least one emission line within the EUV range. In one of the methods, required plasma, often referred to as laser-produced plasma (LPP), can be produced by irradiating a target material containing line-emitting elements required as a laser beam.

One specific LPP technique involves irradiating target material droplets to one or more pre-pulses and main pulses.

In this context, a CO₂ laser can provide specific advantages when a driving laser produces the “main pulse” in an LPP process. This may be especially true for certain target materials, such as tin droplets, For example, one advantage may include the ability to produce a relatively high conversion efficiency, for instance, a ratio between the drive laser input power and the output EUV in-band power.

Light source devices generating EUV light are generally categorized into an off-axis structure and an on-axis structure, and include a rotator-type target material feeder, which stably induces an reflection angle of an optical system and a plasma reaction. The rotor-type light source devices supplying target materials have been widely adopted in conventional technologies due to their ability to stably induce plasma reactions. The rotor-type light source devices are typically designed with off-axis type light output structures depending on light output structures.

The off-axis structure is advantageous in terms of optical system arrangement, but is disadvantageous in that light collection efficiency is deteriorated.

### PATENT LITERATURE

### Patent Documents

Patent Document 1: Korean Patent No. 10-1811306
Patent Document 2: Korean Patent No. 10-0875569
Patent Document 3: Korean Patent No. 10-2207666
Patent Document 4: Korean Patent No. 10-1484937
Patent Document 5: Korean Patent Publication No. 10-2011-0110578
Patent Document 6: Korean Patent Publication No. 10-2008-0041671

### SUMMARY OF THE INVENTION

Accordingly, the present invention has been made to solve the above-mentioned problems occurring in the prior arts, and it is an objective of the present invention to provide a rotational disk structure for an EUV light source device, which can significantly enhance light collection efficiency by improving the light focusing structure while maintaining the existing target material supply system requiring the plasma reaction for the EUV light generation.

Specifically, an objective of the present invention is to provide an optical system of an on-axis structure in an EUV light generation device of a rotational disc structure, thereby significantly enhancing light collection efficiency.

To accomplish the above objective, according to the present invention, there is provided a rotational disk structure for an EUV light source device, including: a rotational disk confining a target material by centrifugal force while rotating to generate EUV light through plasma reactions with the target material in the EUV light source device, wherein the rotational disk includes a plurality of rotational disk ribs supporting a rotational disk rim to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

Moreover, the rotational disk ribs are arranged between the rotational disk hub and the rotational disk rim. The rotational disk ribs are configured to block only 5% to 20% of the light passing through, and are arranged in such a way that an EUV light transmissive area in the light focusing region where the EUV light is connected through the collector mirror is greater than a blocking area.

Furthermore, the rotational disk rib includes a supply channel formed to supply the target material supplied from a target feeder to the rotational disk rim.

Additionally, the rotational disk rib includes a rotational disk hub formed at a rotational center shaft.

In addition, the rotational disk hub includes an upper flange and a lower flange respectively formed on the upper side and the lower side thereof, and the upper flange and the lower flange respectively include upper coupling holes and lower coupling holes for coupling the rotational disk ribs.

Moreover, the rotational disk includes a rim flange, which extends integrally with the rotational disk rim formed to couple the plurality of rotational disk ribs connected through the upper and lower coupling holes, and rim coupling holes formed on the rim flange such that the rotational disk ribs are coupled to the rim coupling holes.

Furthermore, the number of the rotational disk ribs is equal to the number of the upper coupling holes and the number of the lower coupling holes, and the coupled rotational disk ribs are fixed to the rim coupling holes.

Additionally, the rotational disk hub further includes supply channel ribs coupled to the rotational disk hub to deliver target material supplied from a droplet feeder to the rotational disk rim.

In addition, one side of the supply channel rib is coupled to the rotational disk hub and the other side is coupled to the rotational disk rim.

Moreover, the rotational disk hub connects the upper flange and the lower flange to the rim flange via the upper disk ribs and the lower disk ribs.

Furthermore, the total number of the rotational disk ribs and the total number of the rim coupling holes are equal to the number of upper and lower coupling holes, and the upper coupling holes are connected to the rim coupling holes via the upper disk ribs. The lower coupling holes are connected to the rim coupling holes via the lower disk ribs, and the upper disk ribs and the lower disk ribs are arranged in a manner that they do not overlap at same position, maintaining a predetermined interval therebetween.

In addition, the rim flange is formed in an “L”-shape at the inner edge of the lower disk of the rotational disk rim, and the rim coupling holes are positioned in an area parallel to the lower disk.

Additionally, the rotational disk rib is a wire made of spring steel.

According to the present invention having the above configuration, the on-axis type EUV light source device can provide excellent light collection efficiency through the arrangement of the collector mirror and the structure of the rim formed on the rotational disk to maintain the target material supply structure according to plasma reactions of the EUV light source device and realize the on-axis structure.

### BRIEF DESCRIPTION OF THE DRAWINGS

FIG. 1 is an overall configuration of a rotational disk structure for an EUV light source device according to the present invention.

FIG. 2 is a plan view of a rotational disk structure for an EUV light source device according to an embodiment of the present invention.

FIG. 3 is a plan view of a rotational disk structure for an EUV light source device according to another embodiment of the present invention.

FIG. 4 is a plan view of a rotational disk structure for an EUV light source device according to a further embodiment of the present invention.

FIG. 5 is a cross-sectional view of a rotational disk from FIG. 4.

FIG. 6 is a plan view of a rotational disk structure for an EUV light source device according to a still further embodiment of the present invention.

FIG. 7 is a plan view of a shield of the rotational disk structure for an EUV light source device according to the present invention.

FIG. 8 is a plan view illustrating a state in which the rotational disk structure for an EUV light source device is arranged in an off-axis configuration according to the present invention.

FIG. 9 is a sectional view of a rotational disk according to another embodiment of the present invention.

FIG. 10 is a plan view of the rotational disk of FIG. 9.

FIG. 11 is a plan view illustrating a coupled state of a disk rib of the rotational disk according to the present invention.

### DETAILED DESCRIPTION OF THE INVENTION

Hereinafter, a rotational disk structure for an EUV light source device according to the present invention will be described in detail with reference to the accompanying drawings.

The rotational disk structure for an EUV light source device according to the present invention includes a rotational disk confining a target material by centrifugal force while rotating to generate EUV light through plasma reactions with the target material in the EUV light source device, wherein the rotational disk includes a plurality of rotational disk ribs supporting a rotational disk rim to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

The rotational disk structure for an EUV light source device, according to the present invention, applies a target material supply device with a superior structure for generating an EUV light source and applies an on-axis type light focusing structure, thus significantly enhancing light collection efficiency compared to conventional EUV light source devices.

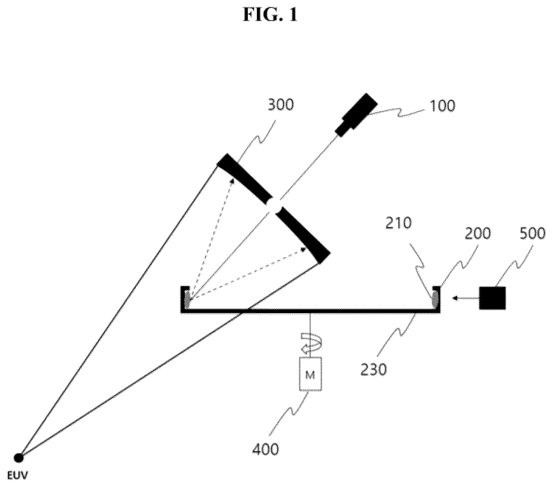

FIG. 1 is an overall configuration of a rotational disk structure for an EUV light source device according to the present invention.

The EUV light source device according to the present invention primarily includes: a laser source 100, a rotational disk 200 which confines molten target material in a reaction space using centrifugal force for plasma reactions; a heating means 500 for melting the target material 210 located in the reaction space of the rotational disk 200; and a collector mirror 300 which irradiates the beam output from the laser source 100 to the target material by allowing the beam to pass centrally, receives the reflected EUV light, and collects the EUV light to the same incident light axis. According to the technical concept of the present invention, the rotational disk 200 includes rotational disk ribs 230 with a penetration structure relative to a predetermined area among the light focusing region where the EUV light is focused through the collector mirror 300.

In one embodiment of the present invention, the laser source 100 may be a laser source with a pulse frequency ranging from 50 kHz to 200 kHz.

Additionally, the RPM of the rotational disk 200 can be determined according to the pulse repetition rate of the laser source, and the rotational speed of the rotational disk can be determined by a laser repetition rate.

Accordingly, a portion of the EUV light collected and output by the collector mirror 300 is designed to pass through (or penetrate) the rotational disk ribs 230 of the rotational disk 200 in an on-axis type optical output structure, thus effectively solving the problem of conventional arts where light focusing amount is reduced in the conventional off-axis structures.

Here, the heating means 500 for melting the target material 210 preferably surrounds the exterior of the rotational disk and heats the target material supplied to the inner surface (rim) of the rotational disk to melt the target material. The heating means can use various heating elements, such as laser heating, induction methods, or ceramic-based heating elements.

Furthermore, the collector mirror 300 may include a separate heating device (not shown). The heating device can be used in a chamber of the EUV light source device to clean off fragmented target material particles, which may be generated by the target material and might interfere with the optical properties of the collector mirror or other optical systems and components, by heating the collector mirror, optical systems or components. Therefore, the heating device can be adopted as a cleaning means, and can be configured inside the chamber of the EUV light source device to remove fragment particles.

Therefore, the present invention can provide a fragment removal function using the heating device for removing fragments generated by the target material in the rotational disk-based EUV light source device.

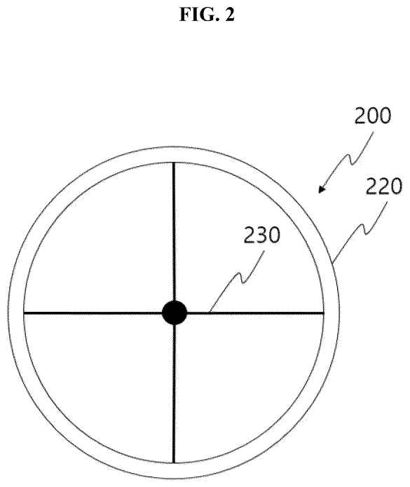

FIG. 2 is a plan view of a rotational disk of the rotational disk structure for the EUV light source device according to an embodiment of the present invention.

FIG. 2 illustrates the rotational disk 200 in a planar view. The rotational disk 200 has a circular structure, and rotates via a driving means. In this instance, the rotational disk 200 includes: a rotational disk rim 220 for holding the target material; and a plurality of rotational disk ribs 230 supporting the rotational disk rim 220 from a rotary shaft.

The plurality of rotational disk ribs 230 are configured to allow EUV light collected by the collector mirror 300 to penetrate when the light is collected in the on-axis manner, such that light focused by the collector mirror 300 can be penetrated.

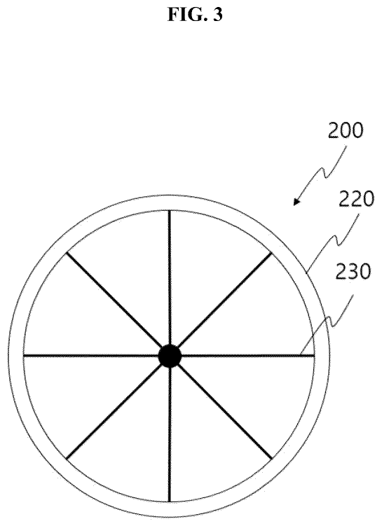

FIG. 3 is a plan view of a rotational disk structure for an EUV light source device according to another embodiment of the present invention.

The rotational disk ribs 230, preferably, has a spoke structure to minimize interference when the focused EUV light is penetrated.

Since the rotational disk is configured to have a plurality of spokes, the rotational disk ribs of the rotational disk can effectively collect the generated EUV light when collecting the light focused on the collector mirror in the on-axis manner.

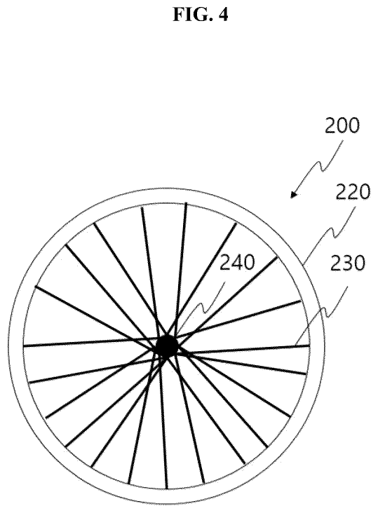

FIG. 4 is a plan view of a rotational disk structure for an EUV light source device according to a further embodiment of the present invention.

In the present invention, to ensure the structural stability of the rotational disk 200, the rotational disk rim 220, and the rotational disk ribs 230, various coupling structures between the rotational disk rim 220 and the rotational disk ribs 230 can be proposed.

As illustrated, a rotational disk hub 240 may be configured at the rotational center shaft, and the rotational disk ribs 230 are assembled between the rotational disk hub 240 and the rotational disk rim 220 in a cross-type (tangent-type) structure. The cross-type structure is configured such that the plurality of rotational disk ribs (spokes) are intersected to support each other, thereby enhancing rigidity to safely withstand external resistance, such as torsion of the rotational disk rim 220 or lateral impacts, by rotational forces. The number of intersecting rotational disk ribs can range from one to four according to patterns.

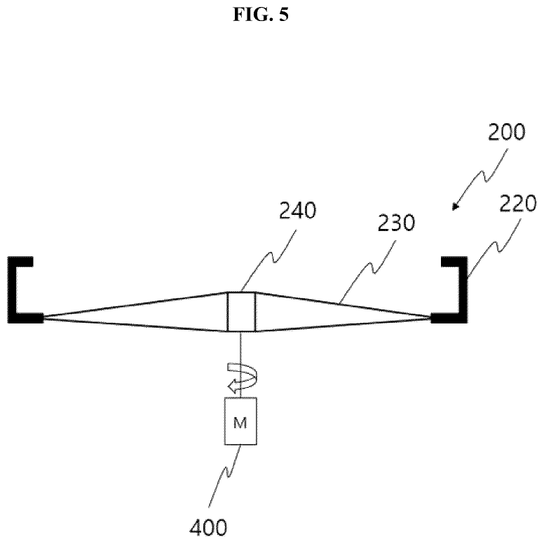

FIG. 5 is a cross-sectional view of a rotational disk from FIG. 4. The rotational disk hub 240 is provided at the rotational disk shaft, and the rotational disk ribs 230 intersect to support the rotational disk rim 220. The rotational disk hub 240 is coupled to a driving means 400 to receive rotational force, confines the target material located on the rotational disk rim 220 by centrifugal force, and reacts with the laser emitted from the laser source to generate EUV light through plasma reactions.

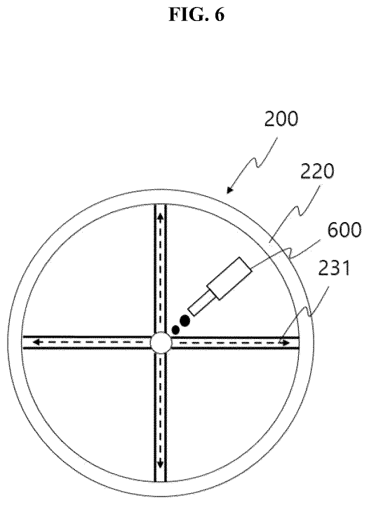

FIG. 6 is a plan view of a rotational disk structure for an EUV light source device according to a still further embodiment of the present invention.

In the still further embodiment of the present invention, the rotational disk ribs 230 includes supply channels 231 of a predetermined width to supply the target material supplied from a target feeder located, which feeds the target material from the rotational center shaft, to the rotational disk rim. A droplet feeder 600 for supplying the target material is positioned above the center shaft.

When the plasma reactions are induced to generate EUV light, the target material positioned on the rotational disk rim decreases, and the droplet feeder 600 continuously supplies the reduced amount of target material, thus providing stable plasma reactions.

As described above, the on-axis type EUV light source device can provide excellent light collection efficiency through the arrangement of the collector mirror and the structure of the rim formed on the rotational disk to maintain the target material supply structure according to plasma reactions of the EUV light source device and realize the on-axis structure.

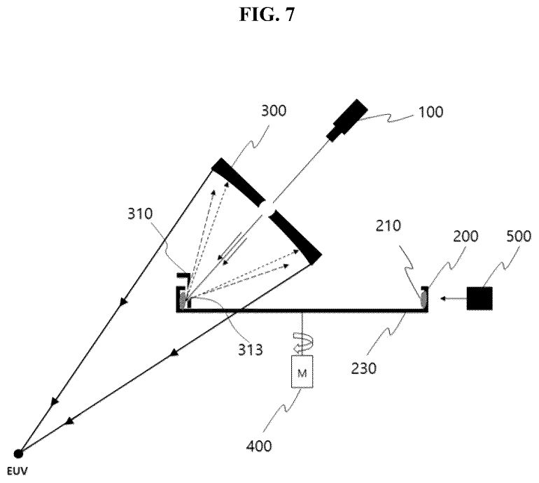

FIG. 7 is a plan view of a shield of the rotational disk structure for the EUV light source device according to the present invention. Since fragmented target material particles may be generated by the target material in the EUV light source device on the collector mirror and a plurality of optical systems or components and might interfere with the optical properties, a shield 310 for blocking the fragmented particles can be arranged.

The shield 301 is positioned to surround the target material placed on the rotational disk rim, thereby preventing fragment particles generated from the target material.

In this instance, the shield includes a single through-hole 313 to allow the beam emitted from the laser source 100 to irradiate to the target material and allow the collector mirror 300 to receive the EUV light reflected from the target material. The single through-hole can be used as a penetration hole through which the incident beam irradiated to the target material and the reflective beam reflected from the target material pass.

If two holes are formed in the shield for the incident beam and the reflective beam, there may occur a problem in arrangement of the incident beam and the reflective beam due to interference between the two holes. However, using a single through-hole solves the problem.

Accordingly, the shield with the single hole is advantageous for collecting EUV light over a wide solid angle and blocking simultaneously generated fragments from the optical systems.

The present invention has been described primarily in terms of the on-axis method, but can also be configured in an off-axis manner if necessary.

That is, as occasion demands, the collector mirror for collecting EUV light may have a spherical, aspherical, or elliptical shape to collect light in an on-axis manner or in an off-axis manner.

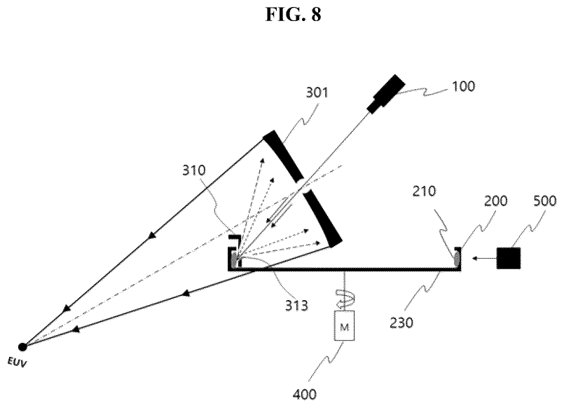

FIG. 8 is a plan view illustrating the EUV light source device with the off-axis type light collection structure to which the target material feeder with an excellent structure for generating EUV light is applied.

As illustrated in FIG. 8, the shield includes a single through-hole 313 to allow the beam emitted from the laser source 100 to irradiate to the target material and allow the collector mirror 300 to receive the EUV light reflected from the target material. The single through-hole can be used as a penetration hole through which the incident beam irradiated to the target material and the reflective beam reflected from the target material pass.

The beam incident on an off-collector mirror 301 is collected to generate EUV light. At this time, an off-center axis C2 of the off-collector mirror 301 is not parallel to a center axis C1 of the laser beam emitted from the laser source and incident on the target material, thus the off-center axis C2 of the off-collector mirror 301 and the center axis C1 of the laser beam form an off-axis configuration.

Such an arrangement helps to avoid interference with peripheral equipment or the rotational disk.

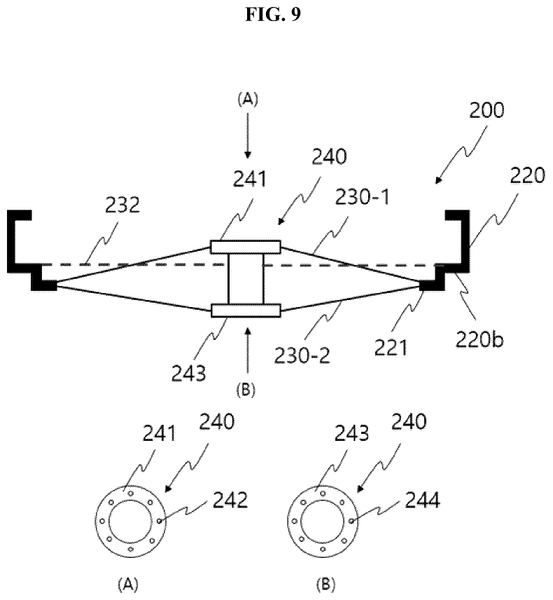

FIG. 9 is a plan view of a rotational disk according to another embodiment of the present invention.

As illustrated, the rotational disk according to the present invention includes a rotational disk hub 240 to have a spoke structure, and the rotational disk hub 240 includes an upper flange 241 and a lower flange 242 respectively formed on the upper side and the lower side thereof.

Additionally, as illustrated in FIG. 9(A), the upper flange 241 has a plurality of upper coupling holes 242 formed along the periphery of the upper flange 241 to couple the disk hub, and as illustrated in FIG. 9(B), the lower flange 243 has a plurality of lower coupling holes 244.

In this instance, a rim flange 221 is formed in an “L”-shape at the inner edge of the lower disk 220b of the rotational disk rim 220, and rim coupling holes 222 are positioned at an area parallel to the lower disk 220b.

As described above, the rotational disk according to the present invention includes one disk hub 240, and includes an upper disk rib 230-1 and a lower disk rib 230-2 are respectively provided through the upper flange 241 and the lower flange 243 to form the rotational disk.

Additionally, the rim flange 221 integrally extending from the rotational disk rim 220, and the rotational disk ribs are connected to the rim flange 221.

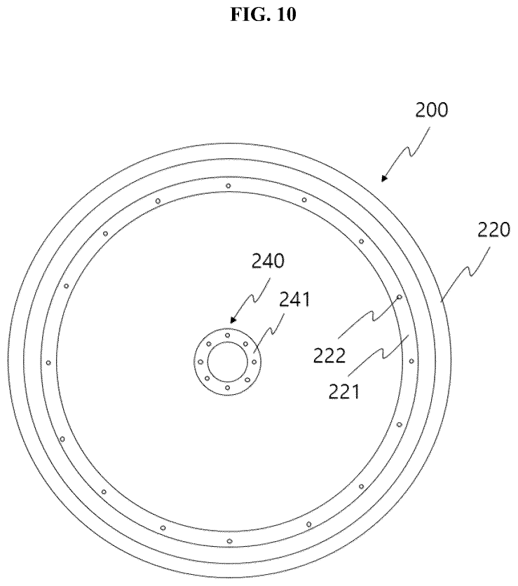

FIG. 10 is a plan view of the rotational disk illustrated in FIG. 9.

FIG. 10 is a plan view of the rotational disk, wherein the rim coupling holes 222 are formed at the innermost part and connected to the rotational disk ribs. The rim coupling holes 222 are formed in the rim flange 221, which extends integrally with the rotational disk rim.

The rim coupling holes 222 formed along the periphery of the rim flange 221 and are formed to correspond in number to the upper coupling holes and the lower coupling holes. As a preferred example, the number of the rim coupling holes 222 is in multiples of two, and the disk ribs coupled to the upper and lower coupling holes are connected to the rim coupling holes 222.

Furthermore, the total number of the rotational disk ribs and the total number of the rim coupling holes 222 are equal to the number of upper and lower coupling holes. The upper coupling holes are connected to the rim coupling holes via the upper disk ribs 230-1,

Here, the lower coupling holes are connected to the rim coupling holes via the lower disk ribs 230-2. The upper disk ribs 230-1 and the lower disk ribs 230-2 are arranged in a manner that they do not overlap at the same position, maintaining a predetermined interval between them.

Additionally, the rim flange 221 is formed in an “L”-shape at the inner edge of the lower disk 220b of the rotational disk rim 220, and the rim coupling holes 222 are positioned in the area parallel to the lower disk 220b.

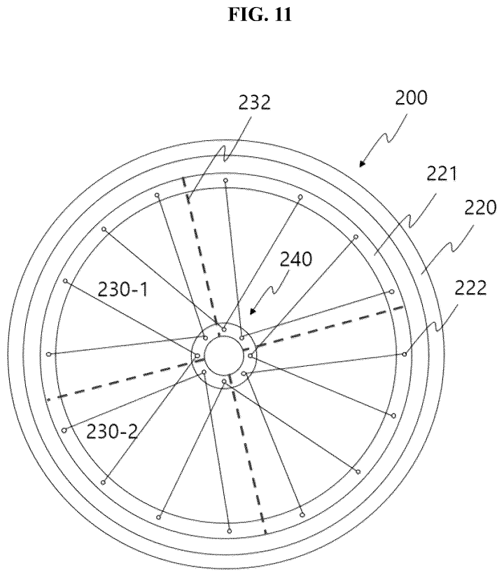

FIG. 11 is a plan view illustrating the state where the disk ribs of the rotational disk are coupled according to the present invention.

FIG. 11 is a plan view illustrating a coupled state of the disk rib of the rotational disk according to the present invention.

FIG. 11 illustrates the state in which the rotational disk hub 240 and the rotational disk 200 are coupled. The disk ribs are connected to the rim coupling holes 222 via the upper and lower coupling holes respectively formed in the upper flange and the lower flange of the rotational disk hub 240. In this instance, the upper disk ribs 230-1 connected to the upper flange and the lower disk ribs 230-2 connected to the lower flange start from the same point but are coupled to rim coupling holes in different positions.

In addition, the rotational disk ribs include supply channel ribs 232 separately configured. As mentioned above, to deliver the target material from the center to the rotational disk rim when the target material is supplied from the rotational center shaft, besides the rotational disk ribs, the supply channel ribs 232 are additionally formed, providing the structure to supply the target material. Although not specifically illustrated in the drawings, the supply channel ribs 232 are coupled with the rotational disk hub and has a central communication structure to receive the target material supplied from the droplet feeder 600.

As described above, the supply channel ribs are coupled in a cross-type to secure the rigidity of the rotational disk and satisfy strength requirements against deformation caused by twisting or rotational forces, thereby providing structural stability for the rotational disk.

While the preferred embodiments of the present invention have been described and illustrated to exemplify the principles of the present invention, the present invention is not limited to the aforementioned specific embodiments. It will be appreciated to those skilled in the art that the present invention can be changed and modified in various manners without departing from the spirit and scope of the present invention. Accordingly, all proper changes, modifications, and equivalents should be construed as belonging to the scope of the present invention.

What is claimed is:

1. A rotational disk structure for an EUV light source device, comprising:
a rotational disk confining a target material by centrifugal force while rotating to generate EUV light through plasma reactions with the target material in the EUV light source device,
wherein the rotational disk includes a plurality of rotational disk ribs supporting a rotational disk rim to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

2. The rotational disk structure according to claim 1, wherein the rotational disk ribs are arranged between the rotational disk hub and the rotational disk rim, and
wherein the rotational disk ribs are configured to block only 5% to 20% of the light passing through, and are arranged in such a way that an EUV light transmissive area in the light focusing region where the EUV light is connected through the collector mirror is greater than a blocking area.

3. The rotational disk structure according to claim 1, wherein the rotational disk rib includes a supply channel formed to supply the target material supplied from a target feeder to the rotational disk rim.

4. The rotational disk structure according to claim 1, wherein the rotational disk rib includes a rotational disk hub formed at a rotational center shaft.

5. The rotational disk structure according to claim 4, wherein the rotational disk hub includes an upper flange and a lower flange respectively formed on the upper side and the lower side thereof, and the upper flange and the lower flange respectively include upper coupling holes and lower coupling holes for coupling the rotational disk ribs.

6. The rotational disk structure according to claim 5, wherein the rotational disk includes:
a rim flange, which extends integrally with the rotational disk rim formed to couple the plurality of rotational disk ribs connected through the upper and lower coupling holes, and rim coupling holes formed on the rim flange such that the rotational disk ribs are coupled to the rim coupling holes.

7. The rotational disk structure according to claim 6, wherein the number of the rotational disk ribs is equal to the number of the upper coupling holes and the number of the lower coupling holes, and the coupled rotational disk ribs are fixed to the rim coupling holes.

8. The rotational disk structure according to claim 3, wherein the rotational disk hub further includes supply channel ribs coupled to the rotational disk hub to deliver target material supplied from a droplet feeder to the rotational disk rim.

9. The rotational disk structure according to claim 8, wherein one side of the supply channel rib is coupled to the rotational disk hub and the other side is coupled to the rotational disk rim.

10. The rotational disk structure according to claim 6, wherein the rotational disk hub connects the upper flange and the lower flange to the rim flange via the upper disk ribs and the lower disk ribs.

11. The rotational disk structure according to claim 10, wherein the total number of the rotational disk ribs and the total number of the rim coupling holes are equal to the number of upper and lower coupling holes, and the upper coupling holes are connected to the rim coupling holes via the upper disk ribs,
wherein the lower coupling holes are connected to the rim coupling holes via the lower disk ribs, and
wherein the upper disk ribs and the lower disk ribs are arranged in a manner that they do not overlap at the same position, maintaining a predetermined interval therebetween.

12. The rotational disk structure according to claim 6, wherein the rim flange is formed in an “L”-shape at the inner edge of the lower disk of the rotational disk rim, and the rim coupling holes are positioned in an area parallel to the lower disk.

13. The rotational disk structure according to claim 6, wherein the rotational disk rib is a wire made of spring steel.
